(19) United States
(12) Patent Application Publication
(10) Pub. No.: US 2003/0172379 A1
(43) Pub. Date: Sep. 11, 2003

(54) Digital CATV tuner

(76) Inventor: Syuuji Matsuura, Ikoma-shi (JP)

Correspondence Address: BIRCH STEWART KOLASCH & BIRCH, PO BOX 747, FALLS CHURCH, VA, 22040-0747, US

(21) Appl. No.: 10/315,137

(22) Filed: Dec. 10, 2002

(30) Foreign Application Priority Data
Mar. 6, 2002 (JP) 2002-059963(P)

(51) Int. Cl. H04N 5/445; H04N 7/173

(52) U.S. Cl. 725/38; 725/127

(57) ABSTRACT

In the digital CATV tuner, gain of a reception signal of a plurality of frequency bands is controlled by a PIN AGC circuit, a reception signal for each of the frequency bands selected from the reception signal is high-frequency amplified by a high-frequency amplifier circuits, a local oscillation signal corresponding to the frequency band to be received from the plurality of the local oscillation signal from local oscillation circuits and the high-frequency amplified reception signal for each of the frequency band are mixed by a mixer to output an intermediate frequency signal, and a digital signal component is obtained from the intermediate frequency signal. Therefore, various characteristics can be improved.

### BACKGROUND OF THE INVENTION

1. Field of the Invention

The present invention relates to a digital CATV tuner, and specifically, to a digital CATV tuner used as a front end in a single conversion mode.

2. Description of the Background Art

In the years 1998 to 2001, three types of digital television broadcastings became available worldwide. In order to receive such digital television broadcastings, a digital set box (hereinafter referred to as STB) is used. In STB, input streams of the digital broadcastings are all in accordance with MPEG2, and outputs are all provided to television receivers. Specifically, no matter whether it is for terrestrial, satellite, or cable television broadcasting, STB employs the same structure in general. It should be noted that front end circuits, CA (Conditional Access) mode, software that depends on mode of data broadcasting service, a digital interface for connecting to an external device, and the like are different depending on the type of the service or the provider of the service.

FIG. 2 is a block diagram of a conventional single conversion tuner. In FIG. 2, the single conversion tuner is adopted to divided bands including a UHF band (B3 band) receiving 470-860 MHz, a VHF High band (B2 band) receiving 170-470 MHz, and a VHF Low band (B1 band) receiving 54-170 MHz band, and it is structured with receiving circuits for respective bands. It should be noted that the band division is not limited to the frequencies above.

A CATV signal is passed through an HPF (High Pass Filter) 2 of an IF filter, input to input switching circuits 3, 4 and 5 and thus switched to corresponding high-frequency amplifier circuits of the UHF band, the VHF High band, and the VHF Low band. HPF 2 is a filter having an attenuation band of 5-46 MHz and a passband of 54 MHz and above, and thus frequency components of the CATV signal 54 MHz and above pass the filter.

The circuitry of one band is configured to be operative corresponding to a reception channel, while the circuitry of other bands is non-operative.

The CATV signal is switched by input switching circuits 3-5, thereafter tuned by high-frequency amplifier input tuning circuits 7, 8 and 9, and amplified by high-frequency amplifier circuits 11, 12 and 13, from which a reception signal is obtained by high-frequency amplifier output tuning circuits 19, 20, and 21. The signal thus obtained by the high-frequency amplifier circuits is frequency-converted by frequency converter circuits structured with mixers 23, 24 and 25 and local oscillation circuits 27, 28 and 29, input to intermediate frequency amplifier circuit 31, and thus IF amplified and output from IF output terminal 32. An AGC voltage is applied to an AGC terminal 18, and then to high-frequency amplifier circuits 11, 12 and 13 via resistors 15, 16 and 17.

In the conventional digital CATV tuner, a double conversion mode has becoming popular, in which a received signal is frequency-converted into a first intermediate frequency signal, and frequency-converted again into a second intermediate frequency signal and thus output. With the double conversion mode, however, it is difficult to address economical demands for recent tuner.

Attempts have been made to solve the problem of the economy by employing IC for a part of tuner circuits, which practically fail to attain the performance comparative to an analog tuner. Therefore, from the viewpoint of the economy, a tuner of the single conversion mode as shown in FIG. 2 is rather advantageous. The following problems, however, are involved.

The conventional tuner as shown in FIG. 2 is arranged such that signals of the VHF High band and the VHF Low band are converted to intermediate frequency signals by mixers 24 and 25, and then input to an intermediate frequency amplifier circuit 31 with an intermediate frequency signal of the UHF band. In this arrangement, since the intermediate frequency signal of each band is high in level, it tends to mix into an adjacent band. If the intermediate frequency signal of the VHF band mixes into the VHF Low band, for example, then a distortion is generated.

When a reception signal is a digital channel signal, a distortion component appears as a noise, and when the reception signal is an analog channel, the distortion component becomes a beat and appears as stripes on a television display. Thus, in order to prevent these stripes from appearing on the television display, a relative proportion of the beat components and the signal level is required to be 57 dB and above.

In the conventional tuner of the single conversion mode, since high-frequency amplifier circuits 11, 12 and 13 as shown in FIG. 2 are provided with an RF AGC function, a distortion IM (Inter Modulation) and X-mod (Cross Modulation) of CSO (Composite System Order Beat) and CTB (Composite Triple Beat), which are nonlinear distortions specifically when an amount of attenuated gain is −10 to −20 dB, are approximately −50 dBc, and thus it should be improved.

Additionally, in the conventional tuner of the single conversion mode, a large sensitivity deviation of approximately 5 to 10 dB exists between channels, and it should be improved. Additionally, transmission characteristics of a select channel may undesirably vary due to the AGC characteristics.

Since high-frequency amplifier input tuning circuits 7, 8 and 9 are the input circuits, it is difficult to compensate input return loss over all of the reception bands. Further, the local leakage is −20 to −30 dBmV, which does not satisfy the DOCSIS requirement standard (the standard for cable modems in North America) of −40 dBmV, and hence it should be improved. Still further, it employs a tuning mode by high-frequency amplifier input tuning circuits 7-9 and high-frequency amplifier output tuning circuits 19-21 with video signal rejection ratio of −50 dBc and above, and thus it should be improved.

Further, isolation is approximately 40 to 50 dB, while the same in a tuner of the double conversion mode is 70 dB and above, and thus it should be improved.

### SUMMARY OF THE INVENTION

Therefore, a principle object of the present invention is to provide a digital CATV tuner that can improve various characteristics as above.

In the digital CATV tuner according to the present invention, gain of a reception signal of a plurality of frequency bands is controlled, a reception signal for each of the frequency bands selected from the reception signal is high-frequency amplified, a local oscillation signal corresponding to the frequency band to be received from the plurality of the local oscillation signals and the high-frequency amplified reception signal for each of the frequency bands are mixed to output an intermediate frequency signal, and a digital signal component is obtained from the intermediate frequency signal. Therefore, the gain deviation per one frequency band and sensitivity deviation for all of the bands are improved. Further, since the bandwidth per one frequency band is made narrower than in the conventional manner, the tracking characteristics per one channel can be improved.

Still further, since frequency conversion for each of the frequency bands is performed by one mixer circuit, the possible leakage of intermediate frequency signal into adjacent channel to generate the distortion as seen in the conventional manner, can be suppressed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram of a digital CATV tuner in one embodiment of the present invention; and

FIG. 2 is a block diagram of a conventional tuner in a single conversion mode.

### DESCRIPTION OF THE PREFERRED EMBODIMENTS

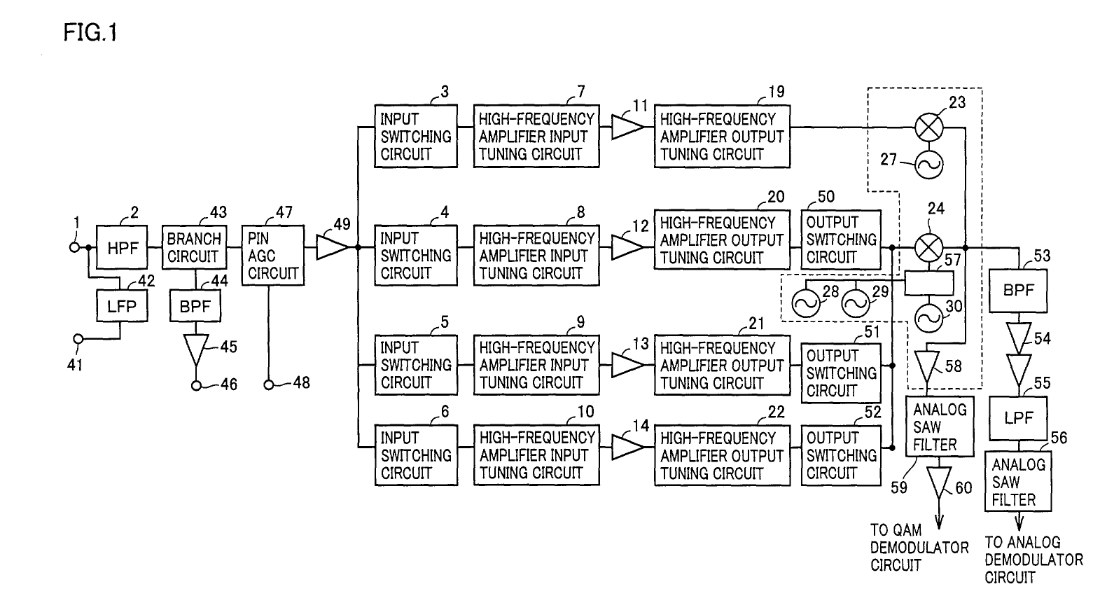

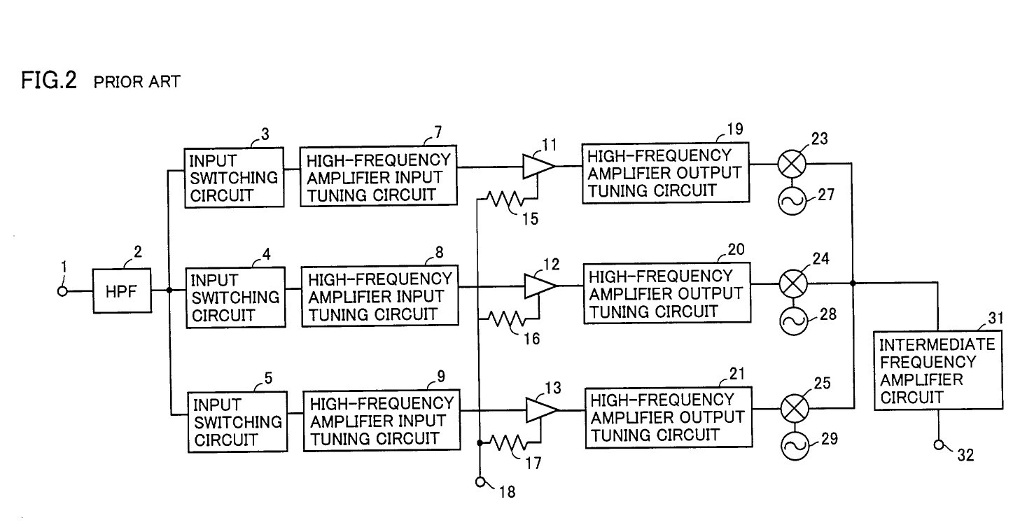

Referring to FIG. 1, a tuner of the present embodiment is arranged, similarly to a conventional tuner shown in FIG. 2, to receive an UHF band (B4 band) receiving 470-860 MHz. On the other hand, the VHF band that is conventionally divided into two bands is divided into three bands in this embodiment. Specifically, the three bands are a VHF High band (B3 band) receiving 240-470 MHz, a VHF Mid band (B2 band) receiving 120-240 MHz, and a VHF Low band (B1 band) receiving 54-120 MHz, and receiving circuits are provided for each band.

Specifically, as for CATV signals, up signals are operated at 5-42 MHz (or 5-15 MHz), and down signals are operated at 54-860 MHz. A cable line for the down signals is connected to a terminal 1, and the up signals are connected to a data terminal 41. An up signal is a data signal which is modulated by quadrature phase shift keying (QPSK) with QPSK transmitter, which is not shown. The data signal is connected to terminal 1 via an upstream circuit 42 arranged with an LPF (Low Pass Filter, or a Return Path Filter).

A downstream signal, that is, a communication down signal from a CATV station, is passed through HPF 2 of the IF filter, a branch circuit 43, and output from BPF (Band Pass Filter) 44. Then, a branch loss is corrected at an amplifier circuit 45, and from an FM Tap terminal 46, the signal is output to a FSK demodulator circuit or a QAM demodulator circuit, which are not shown. FM Tap terminal 46 is provided for attaining a communication between the CATV station and STB including this tuner. The downstream signal is also referred to as OOB (Out Of Band), and it is a signal at 70-130 MHz or 50-130 MHz band.

The other down signal (analog and digital video signal) is passed through HPF 2, branch circuit 43, a PIN AGC circuit 47, and a broadband amplifier circuit 49 and provided to input switching circuits 3-6. Input switching circuit 3 corresponds to the UHF band, input switching circuit 4 corresponds to the VHF High band, input switching circuit 5 corresponds to the VHF Mid band, and input switching circuit 6 corresponds to the VHF Low band, respectively. PIN AGC circuit 47 is controlled by an AGC controlling signal supplied from an AGC terminal 48.

HPF 2 attenuates components of 5-46 MHz, and then passes components of 54 MHz and above. To outputs of input switching circuits 3, 4, 5, and 6, sequential high-frequency amplifier input tuning circuits 7, 8, 9, and 10, high-frequency amplifier circuits 11, 12, 13, and 14, and high-frequency amplifier output tuning circuits 19, 20, 21 and 22 are connected. To outputs of high-frequency amplifier output tuning circuits 20, 21, 22, which respectively correspond to the VHF High band, the VHF Mid band, the VHF Low band, output switching circuits 50, 51 and 52 are connected, for selecting one of these outputs and outputting the same. The circuitry of one band is configured to be in an operating state corresponding to an reception channel, while the circuitry of other bands is non-operative. When receiving a channel of the UHF band, for example, HPF 2, input switching circuit 3, high-frequency amplifier input tuning circuit 7, high-frequency amplifier circuit 11, high-frequency amplifier output tuning circuit 19, mixer 23, local oscillation circuit 27, BPF 53-analog SAW filter 56, and intermediate frequency amplifier circuit 58-intermediate frequency AGC amplifier circuit 60 are operative, while input switching circuits 4-6, high-frequency amplifier input tuning circuits 8-10, high-frequency amplifier circuits 12-14, high-frequency amplifier output tuning circuits 20-22, output switching circuits 50-52, mixer 24, local oscillation circuits 28-30, and local oscillation switching circuit 57 are the non-operative.

An output of high-frequency amplifier output tuning circuit 19 of the UHF band is provided to mixer 23, which in turn is mixed with a local oscillation signal from local oscillation circuit 27 and thus frequency-converted to an intermediate frequency signal. A signal of any one of the VHF bands is switched by output switching circuits 50, 51 and 52 and thus provided to mixer 24. Local oscillation circuits 28, 29 and 30 are provided corresponding to the VHF High band, the VHF Mid band, the VHF Low band, respectively. Local oscillation switching circuit 57 selects a local oscillation circuit that corresponds to a receiving VHF band, and a selected local oscillation signal is provided to mixer 24.

Mixer 24 mixes the signal of any of the VHF High band, the VHF Mid band, the VHF Low band as selected by output switching circuits 50, 51 and 52, and the local oscillation signal selected by the local oscillation switching circuit, and thus performs frequency-conversion to obtain an intermediate frequency signal. The intermediate frequency signal having frequency-converted by mixers 23 and 24 are provided to BPF 53 and intermediate frequency amplifier circuit 58. When the reception signal is an analog channel signal, an analog channel signal is obtained from the intermediate frequency signal by BPF 53. The analog channel signal thus obtained is provided to intermediate frequency amplifier circuit 54 and amplified, and passed through LPF 55 and analog SAW filter 56, then output from IF output terminal to be transmitted to an analog demodulator circuit, which is not shown.

When the reception signal is a digital channel signal, intermediate frequency amplifier circuit 58 amplifies the intermediate frequency signal and provides to digital SAW filter 59. Digital SAW filter 59 obtains a digital channel signal from the intermediate frequency signal, and via intermediate frequency AGC amplifier circuit 60, provides it to a QAM demodulator circuit, which is not shown.

Mixers 23 and 24, local oscillation circuits 27-30, local oscillation switching circuit 57, and intermediate frequency amplifier circuit 58, all enclosed by a broken line in FIG. 1, are accommodated in one general purpose IC. By employing such a general purpose IC, costs may be reduced.

Next, an operation of the embodiment of the present invention will be described. The gain of the CATV signal input from terminal 1 is controlled by PIN AGC circuit 47. With AGC having an input level of 137 CW and TOP (Take Over Point) of +3 dBmV, for example, when +15 dBmV, CSO may be improved by at least −60 dBc, and IM and X-mod of distortion of CTB may be improved by at least −64 dBc and −60 dBc respectively, thus the performance comparative to distortion level in the double conversion mode can be attained.

The CATV signal with thus controlled gain is provided to broadband amplifier circuit 49, and the input return loss may be compensated over all reception bands. Since broadband amplifier circuit 49 serves as a buffer amplifier for terminal 1 and high-frequency amplifier input tuning circuits 7-10, the isolation and the local leakage can be improved.

Further, the CATV signal is passed through input switching circuits 3-6, tuned at high-frequency amplifier input tuning circuits 7-10, and then high-frequency amplified by high-frequency amplifier circuits 11-14. Since the gain thereof is controlled by PIN AGC circuit 47, high-frequency amplifier circuits 11-14 are set to operate with highest gain. The output of high-frequency amplifier circuits 11-14 is tuned at high-frequency amplifier output tuning circuits 19-22. When a UHF band signal is selected, the UHF band signal is provided from high-frequency amplifier output tuning circuit 19 to mixer 23, then it is mixed with a local oscillation signal from local oscillation circuit 27, and thus it is frequency-converted to an intermediate frequency signal.

When a VHF band signal is selected, any one of the VHF High band signal, the VHF Mid band signal and the VHF Low band signal is provided from high-frequency amplifier output tuning circuits 20, 21, and 22 to mixer 24, then it is mixed with a local oscillation signal from corresponding local oscillation circuit, and thus it is frequency-converted to an intermediate frequency signal.

The conventional tuner shown in FIG. 2 divides the reception band of 54-860 MHz into three bands of the UHF, the VHF High and the VHF Low, whereas in the present embodiment it is divided into four bands of the UHF, the VHF High, the VHF Mid, and the VHF Low, and hence, the gain deviation per one band and the sensitivity deviation for all bands are improved. Additionally, since a bandwidth per one band is narrower compared to the conventional tuner, the tracking characteristics per one channel and the transmission characteristics per 6 MHz bandwidth are improved.

The intermediate frequency signal is provided to BPF 53, which has adjacent channel traps at opposing sides for preventing distortions due to multiwave signals. Thus, distortions can greatly be improved as compared with conventional manner, even after amplifying the intermediate frequency signal by intermediate frequency amplifier circuit 54 at the rear stage. LPF 55 is selected to have a frequency cutoff (fc) of 54 MHz and above, i.e., to pass components of the intermediate frequency signal 54 MHz and below, and thus the isolation is improved.

The intermediate frequency signal is provided to LPF 55, and when a reception signal is an analog channel signal, an analog channel signal is obtained from the intermediate frequency signal by analog SAW filter 56. When reception signal is a digital channel signal, the intermediate frequency signal is amplified by intermediate frequency amplifier circuit 58, and from which a digital channel signal is obtained by digital SAW filter 59. Thereafter, it is amplified by the intermediate frequency AGC amplifier circuit and thus output therefrom.

As above, according to the present embodiment, by dividing the reception band into four bands of the UHF, the VHF High, the VHF Mid, and the VHF Low, the gain deviation per one band and the sensitivity deviation for all bands are improved. Additionally, since a bandwidth per one band is narrower compared to the conventional tuner, the tracking characteristics per one channel is improved.

Further, since the VHF band performs frequency conversion of each band with one mixer 24 by switching local oscillation circuits 28-30, the intermediate frequency signal of each band of the VHF will not leak into an adjacent channel. Accordingly, the relative proportion of signal components to distortion components may be set higher, and thus stripes due to a beat are prevented from appearing on television display.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A digital CATV tuner receiving a reception signal including a digital signal of a plurality of frequency bands, comprising:
a gain control circuit controlling gain of said reception signal of the plurality of frequency bands;
an input tuning circuit selecting a reception signal for each of the frequency bands from said reception signal output from said gain control circuit;
a high-frequency amplifier circuit high-frequency amplifying said reception signal for each of the frequency bands selected by said input tuning circuit;
a plurality of local oscillation circuits each outputting a local oscillation signal corresponding to each of said frequency bands;
a local oscillation switching circuit selecting a local oscillation circuit corresponding to a frequency band to be received from said plurality of local oscillation circuits;
a mixer circuit mixing said reception signal for each of the frequency bands high-frequency amplified by said high-frequency amplifier circuit, and said local oscillation signal from said local oscillation circuit selected by said local oscillation switching circuit to output an intermediate frequency signal; and
a digital filter obtaining a digital signal component from said intermediate frequency signal output from said mixer circuit.

2. The digital CATV tuner according to claim 1, further comprising
a broadband amplifier circuit connected between said gain control circuit and said input tuning circuit.

3. The digital CATV tuner according to claim 1, further comprising
a band pass filter having an adjacent channel trap for obtaining an analog signal component from said intermediate frequency signal output from said mixer circuit.

4. The digital CATV tuner according to claim 3, wherein
a low pass filter for improving isolation is connected to an output of said band pass filter.
